(19) United States
(12) Patent Application Publication
(10) Pub. No.: US 2017/0223597 A1
(43) Pub. Date: Aug. 3, 2017

(54) VOICE AND/OR VIDEO CALL CONTINUITY

(71) Applicant: QUALCOMM Incorporated, San Diego, CA (US)

(72) Inventors: Mahesh Devdatta Telang, San Diego, CA (US); Arif Syed, San Diego, CA (US); Chaithanya Arla, San Diego, CA (US); Xinli Song, San Diego, CA (US)

(21) Appl. No.: 15/010,880

(22) Filed: Jan. 29, 2016

(51) Int. Cl. H04W 36/24

(52) U.S. Cl. CPC H04W 36/24

(57) ABSTRACT

Methods, systems, and devices are described for wireless communication at a wireless device. In some aspects, the wireless device may detect a desired operations change from a first operational state to a second operational state which uses a different number of radio resources than the first operational state. The wireless device may determine that there is an active call on a first radio resource or modem. The wireless device may perform a handover process to transfer the active call from the first radio resource to a second radio resource or modem. The handover process may be performed based on the detecting the operations change. The second radio resource provides a wireless service different from that provided by the first radio resource. The wireless device may disable the first radio resource or modem based on completing the handover process.

### BACKGROUND

Field of the Disclosure

The present disclosure, for example, generally relates to wireless communication systems, and more particularly to voice and/or video call continuity when changing operating modes of a mobile device.

Description of Related Art

Wireless communication systems may be capable of supporting communication with multiple users by sharing the available system resources (e.g., time, frequency, and power). Examples of multiple-access systems include code-division multiple access (CDMA) systems, time-division multiple access (TDMA) systems, frequency-division multiple access (FDMA) systems, and orthogonal frequency-division multiple access (OFDMA) systems (e.g., a Long Term Evolution (LTE) system).

By way of example, a wireless multiple-access communications system may include a number of base stations, each simultaneously supporting communication for multiple communication devices, which may be otherwise known as user equipment (UEs). A base station may communicate with the communication devices on downlink channels (e.g., for transmissions from a base station to a UE) and uplink channels (e.g., for transmissions from a UE to a base station).

A UE may include a cellular radio resource or modem that may be used, for example, to make voice or video calls. However, when a user changes an operating mode of the UE to a radio disabling operating mode (such as to a typical airplane mode), an existing cellular call may be terminated when the cellular modem (which may be wirelessly coupled to an LTE system) is shut off. Thus, a potentially important call may be disconnected as the UE transitions to a typical airplane mode. However, recent regulatory policy initiatives suggest that the Federal Aviation Administration (FAA) and airline companies may allow certain wireless technologies (e.g., wireless fidelity (WiFi)) to be active during takeoff and landing of an aircraft. For at least this consideration, improved methods of maintaining an active call on a UE are desired.

### SUMMARY

The present disclosure relates to improved systems, methods, or apparatuses for voice and/or video call continuity when detecting desired operations changes associated with a wireless device. Techniques are described such that an active call (e.g., voice call or video telephony call) may continue when a wireless device switches to an operating mode that disables one or more radio resources (e.g., a wireless modem and/or associated circuitry and components). Operating modes that disable one or more radio resources include, but are not limited to an airplane mode, low power mode, game mode, and the like. In some aspects, techniques for call continuity may be used by a wireless device that is configured for preexisting operating modes like an airplane mode that, when entered, disconnects all radio resources. In other aspects, techniques for call continuity include defining new operating modes for use by a wireless device such as a modified airplane mode that, when entered, disconnects only some radio resources (e.g., radio resources associated with cellular networks and radio frequencies thereof) and allows other radio resources (e.g., radio resources associated with wireless fidelity (WiFi) networks and radio frequencies thereof) to remain functional when entering the modified airplane mode. In other aspects, techniques for call continuity include defining new operating modes for use by a wireless device such as a modified airplane mode that, when entered, disconnects radio resources (e.g., radio resources associated with cellular networks and radio frequencies thereof and radio resources associated with WiFi networks and radio frequencies thereof) and re-enables some radio resources (e.g., the radio resources associated with WiFi networks and radio frequencies thereof) to be functional when entering the modified airplane mode.

For example, a wireless device may detect a desired operations change on the mobile device. The desired operation change may be related to a user wishing to change to an operating mode that disables one or more radio resources. The desired operation change may also be related to a change of an operating mode triggered by a detected condition (e.g., detecting a low battery condition and proceeding to enter a low power mode). The wireless device may determine that there is an active call on a first radio resource and perform a handover process to transfer the active call from the first radio resource to a second radio resource. The second radio resource of the wireless device may provide a wireless service that is different from that provided by the first radio resource. When the handover process is complete, the wireless device disables the first radio resource, thereby reducing certain radio frequency emissions and/or reducing the power required by the device to transmit and receive using the first radio resource.

A method of wireless communication is described. The method may include detecting a desired operations change on a user equipment (UE) from a first operational state to a second operational state which uses a different number of radio resources than the first operational state, determining that there is an active call on a first radio resource of the UE, performing a handover process to transfer the active call from the first radio resource of the UE to a second radio resource of the UE based at least in part on the detecting the operations change, the second radio resource providing a wireless service different than that provided by the first radio resource, and disabling the first radio resource based at least in part on completing the handover process.

An apparatus for wireless communication is described. The apparats may include means for detecting a desired operations change on a UE from a first operational state to a second operational state which uses a different number of radio resources than the first operational state, means for determining that there is an active call on a first radio resource of the UE, means for performing a handover process to transfer the active call from the first radio resource of the UE to a second radio resource of the UE based at least in part on the detecting the operations change, the second radio resource providing a wireless service different than that provided by the first radio resource, and means for disabling the first radio resource based at least in part on completing the handover process.

A further apparatus for wireless communication is described. The apparatus may include a processor, memory in electronic communication with the processor, and instructions stored in the memory and operable, when executed by the processor, to cause the apparatus to detect a desired operations change on a UE from a first operational state to a second operational state which uses a different number of radio resources than the first operational state, determine that there is an active call on a first radio resource of the UE, perform a handover process to transfer the active call from the first radio resource of the UE to a second radio resource of the UE based at least in part on the detecting the operations change, the second radio resource providing a wireless service different than that provided by the first radio resource, and disable the first radio resource based at least in part on completing the handover process.

A non-transitory computer-readable medium storing code for wireless communication is described. The code may include instructions executable to detect a desired operations change on a UE from a first operational state to a second operational state which uses a different number of radio resources than the first operational state, determine that there is an active call on a first radio resource of the UE, perform a handover process to transfer the active call from the first radio resource of the UE to a second radio resource of the UE based at least in part on the detecting the operations change, the second radio resource providing a wireless service different than that provided by the first radio resource, and disable the first radio resource based at least in part on completing the handover process.

In some examples of the method, apparatuses, or non-transitory computer-readable medium described herein, a notification identifying the active cell is generated. A user call continuity indication to continue the active call may also be received, wherein the performing the handover process is further based at least in part on the user call continuity indication. User network preference information may also be received, wherein the user network preference information is associated with a user preference regarding when a cellular network is to be disabled, and wherein the detecting the desired operations change is based at least in part on the user network preference information.

In some examples of the method, apparatuses, or non-transitory computer-readable medium described herein, the active call is on a cellular network and is associated with a preference for using the cellular network. The preference for using the cellular network may be determined based at least in part on an operating mode of the UE.

In some examples of the method, apparatuses, or non-transitory computer-readable medium described herein, the detecting the desired operations change may include detecting an operating mode change to a limited radio resources operating mode. The limited radio resources operating mode may be a modified airplane mode by which all radio resources associated with a cellular network are disabled and at least one radio resource associated with a non-cellular network remains active.

In some examples of the method, apparatuses, or non-transitory computer-readable medium described herein, the detecting the desired operations change includes detecting a low battery condition and receiving an auto-generated trigger based at least in part on the low battery condition or a user indication to change to the second operational state for conserving power. Detecting the desired operations change may include detecting a change in cellular network services associated with the active call and receiving one of an auto-generated trigger based at least in part on the change in cellular network services or a user indication to change to the second operational state for disabling all radio resources associated with the cellular network services.

In some examples of the method, apparatuses, or non-transitory computer-readable medium described herein, the active call is one of a voice call or a video call. The first radio resource may be associated with a cellular network and the second radio resource is associated with a voice over wireless fidelity (VoWiFi) network.

In some examples of the method, apparatuses, or non-transitory computer-readable medium described herein, a single depress of a modified airplane mode button on a user interface may be detected. Detecting the desired operations change may be in response to detecting the single depress. Determining that there is an active call may be in response to detecting the single depress. Performing a handover process to transfer the active call from the first radio resource of the UE to a second radio resource of the UE based at least in part on the detecting the operations change may include disabling the second radio resource and then enabling the second radio resource.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communications system that supports voice and/or video call continuity techniques in accordance with aspects of the present disclosure.

FIG. 2 illustrates an example of a wireless communications environment in which voice and/or video call continuity techniques may be performed in accordance with aspects of the present disclosure.

FIG. 3 illustrates an example of a user equipment (UE) and associated process flow that supports voice and/or video call continuity in accordance with aspects of the present disclosure.

FIG. 4 illustrates an example of a UE and associated process flow that supports voice and/or video call continuity in accordance with aspects of the present disclosure.

FIGS. 5 through 7 show block diagrams of a wireless device that supports voice and/or video call continuity in accordance with aspects of the present disclosure.

FIG. 8 illustrates a block diagram of a system including a UE that supports voice and/or video call continuity in accordance with aspects of the present disclosure.

FIGS. 9 through 11 illustrate methods for voice and/or video call continuity in accordance with aspects of the present disclosure.

### DETAILED DESCRIPTION

The described features generally relate to improved systems, methods, and apparatuses for continuing a call when detecting desired operations changes such as, but not limited to, entering an operating mode that disables one or more radio resources. In some wireless communication environments, multiple wireless systems and networks (e.g., a Long Term Evolution (LTE)/LTE-Advanced (LTE-A) network, Global System for Mobile Communications (GSM) network, code-division multiple access (CDMA) network, wireless fidelity (WiFi) network, Bluetooth personal area network, etc.) may be available for use by a user equipment (UE), which may be equipped with multiple radio resources for selective and/or simultaneous communication with the multiple wireless systems. However, in such wireless communication environments, use of all such wireless systems and networks may not be allowed. In accordance with some aspects, when a user initiates a change to an operating mode that disables radio resources of the UE, the UE may perform a handover process associated with an active voice call from a first radio resource, for example, using voice over LTE (VoLTE) technology to a second radio resource using, for example, voice over WiFi (VoWiFi) technology to maintain call continuity. The first radio resource using VoLTE technology may then be disabled without affecting the active call.

For example, a user of the UE may need, desire or wish to disable the radio resources associated with certain networks and may wish to allow the radio resource associated with other networks to remain active. For example, a user may wish to continue an active voice call on an airplane when requested to discontinue cellular communications as the airplane begins to taxi and take off. However, initiating or changing to a traditional airplane mode will disable all radio resources and disconnect the active call. In accordance with an example of present aspects, the user may initiate a change from an existing operating mode to an operating mode of the UE that disables all cellular communications (e.g., an airplane mode or a low power mode). However, before disabling all cellular communications, the UE may detect that the active voice call is still active on a VoLTE-capable modem (e.g., using a cellular network) and may perform a handover process that transfers the existing voice call to a VoWiFi-capable modem. In some instances, the UE may query a user to ascertain whether the handover process should occur. After handover, the UE may then disable the VoLTE-capable modem (as well as other cellular network radio resources). In this manner, the active voice call will continue on the UE using WiFi without dropping the ongoing voice call.

In another example, a user may be travelling internationally and may wish to continue an active video telephony call when transitioning between cellular networks, but the user may not wish to incur the charges associated with another provider's cellular network. The user may initiate a change from an existing operating mode to an operating mode of the UE that disables some or all cellular communications (e.g., a cellular data off mode or a low power mode). The UE may detect that the active video telephony call is still active on an VoLTE-capable modem (e.g., using a cellular network) and may perform a handover process that transfers the active video telephony call to a VoWiFi-capable modem. The UE may then disable the VoLTE-capable modem, and the existing video telephony call will continue on the UE using WiFi without incurring charges by the other provider's cellular network. In some aspects of the above examples, the user may initiate a change from an existing operating mode to an operating mode of the UE that disables some or all cellular communications by a single depress of a button on a user interface, and the remaining steps occur (e.g., automatically) in response to the single depress. In this manner, a modified or smart airplane mode and/or modified or smart low power mode is introduced in accordance with aspects.

Aspects of the disclosure are initially described in the context of a wireless communication system. Non-limiting examples are then provided in which a wireless device performs a handover process for an active call based on a desired operations change. Aspects of the disclosure are further illustrated by and described with reference to apparatus diagrams, system diagrams, and flowcharts that relate to voice and video call continuity techniques.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

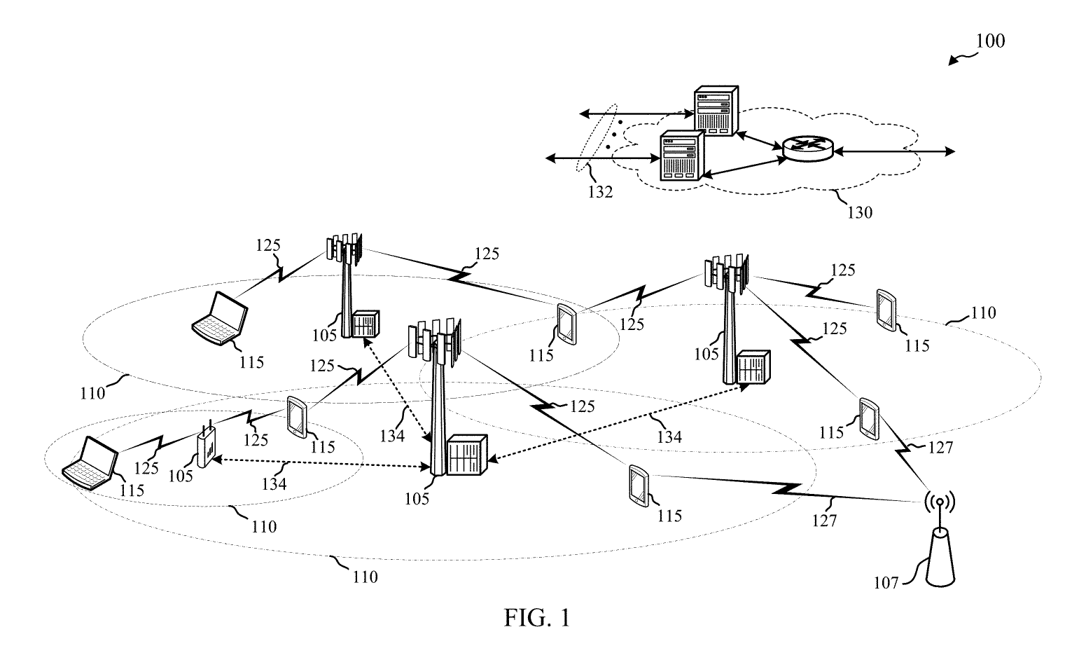

FIG. 1 illustrates an example of a wireless communications system 100 in accordance with various aspects of the present disclosure. The wireless communications system 100 includes base stations 105, access point (AP) 107, UEs 115, and a core network 130. In some examples, the wireless communications system 100 may be an LTE/LTE-A network. Additional wireless communications systems may be widely deployed along with wireless communications system 100 to provide various types of communication options and content such as voice, video, packet data, messaging, broadcast, and so on. Such a wireless communications environment may be uses to support techniques for voice and/or video call continuity when changing operating modes of a UE 115.

The term “handover” is often used in connection with transfer of a UE 115 from a serving network device to another network device. For example, in some cases, a UE 115 may be transferred from a serving base station 105 (e.g., known as the source base station) to another station such as base station 105 (e.g., known as the target base station). For example, the UE 115 may be moving into the coverage area of the target base station 105, or the target base station 105 may be capable of providing better service for the UE 115 or relieving the source base station 105 of excess load. The transition may be referred to as a “handover” between base stations. Prior to such a handover, the source base station 105 may configure the UE 115 with procedures for measuring the signal quality of neighboring base stations 105. The UE 115 may then respond with a measurement report. The source base station 105 may use the measurement report to make the handover decision. The decision may also be based on radio resource management (RRM) factors such as network load and interference mitigation.

When the base station handover decision is made, the source base station 105 may send a handover request message to the target base station 105, which may include context information to prepare the target base station 105 to serve the UE 115. The target base station 105 may make an admission control decision, for example, to ensure that it can meet the quality of service (QoS) standards of the UE 115. The target base station 105 may then configure resources for the incoming UE 115, and send a handover request acknowledge message to the source base station 105, which may include radio resource control (RRC) information to be passed on to the UE 115. The source base station 105 may then direct the UE 115 to perform the base station handover, and pass a status transfer message to the target base station with packet data convergence protocol (PDCP) bearer status information. The UE 115 may attach to the target base station via a random access channel (RACH) procedure.

The handover process may also occur between a base station 105 and an AP 107. As explained in greater detail herein, handover to an AP 107 may occur in instances when a user elects to restrict the cellular radio resources available to the UE 115 and yet still maintain an ongoing voice or video call.

An AP 107 and an associated set of UEs 115 and may be referred to as a basic service set (BSS), where the UEs 115 are also acting as stations (STAs). A distribution system (DS) (not shown) may be used to couple the AP 107 in an extended basic service set (ESS), which is a set of coupled BSSs. In some cases, the coverage area of an AP 105 may be divided into sectors (also not shown). A wireless local area network (WLAN) may include AP 107 and APs of different types (e.g., metropolitan area, home network, etc.), with varying and overlapping coverage areas along with the geographic coverage areas 110 of the base stations. UEs 115 and AP 107 may communicate according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, etc. In other implementations, peer-to-peer connections or ad hoc networks may be implemented within the WLAN.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115.

UEs 115 may also communicate with an AP 107 using wireless links 127 via DL and UL transmissions. The DL (or forward link) may refer to the wireless communication link from the AP 107 to the UE 115, and the UL (or reverse link) may refer to the wireless communication link from the UE 115 to the AP 107.

UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, or like terminology. A UE 115 may also be a cellular phone, a wireless modem, a handheld device, a personal computer, a tablet, a personal electronic device, a machine type communication (MTC) device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

In some cases, LTE networks may be designed for transfer of data packets, and may use a circuit switched fall back (CSFB) for voice communications. However, an LTE network may also be used for voice communications using a packet based system similar to voice over internet protocol (VoIP) applications such as Skype. This may be accomplished using VoLTE technology. There may be several key differences between VoLTE and VoIP. For example, VoLTE service may include an explicit QoS target. To achieve the QoS threshold in poor radio conditions, VoLTE packets may utilize internet protocol (IP) multimedia subsystem (IMS) and other network features to ensure low latency and improved error correction.

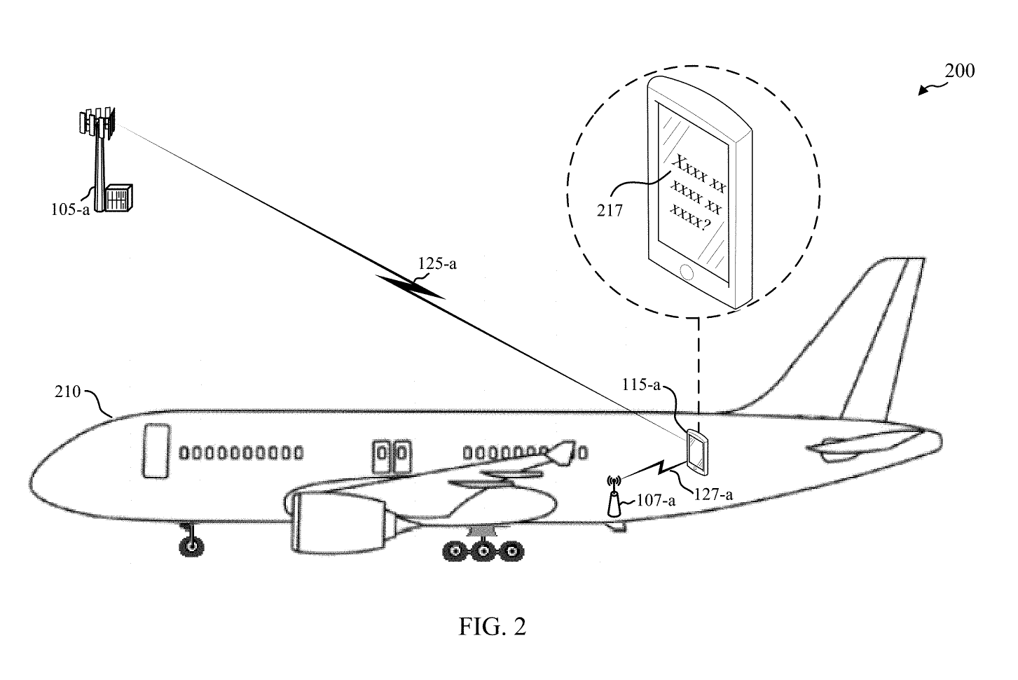

FIG. 2 illustrates an example of a wireless communications environment 200 in which voice and/or video call continuity techniques may be performed in accordance with aspects of the present disclosure. Wireless communications environment 200 may include base station 105-a, AP 107-a, and UE 115-a, which may be examples of the corresponding devices described with reference to FIG. 1.

In one non-limiting example, wireless communications environment 200 is onboard an airplane 210 that is preparing to taxi for takeoff. A user utilizing UE 115-a originates a voice call over an LTE network using an IMS via communications link 125-a and base station 105-a. An attendant announces that the airplane 210 has been cleared for takeoff and that cellular communications are no longer allowed, and therefore, must be ceased. Thus, the user initiates a change from an existing operating mode of the UE 115-a in which a radio resource is used for cellular communication over an LTE network to a smart airplane mode that disables all cellular communications (e.g., and, at least initially, WiFi communications).

Airplane mode, as well as other operating modes (e.g., game mode and low power mode) disable or turn off all radio communications between UE 115-a and base station 105-a as well as between UE 115-a and other wireless devices (e.g., AP 107-a and other STAs). Accordingly, when the UE 115-a enters airplane mode, radio communications coupled to cellular networks and WiFi networks or using FM radio technologies or Bluetooth technologies are turned off and disabled. However, in airplane mode other non-cellular networks and technologies like WiFi, FM radio, and Bluetooth can be turned back by a user-initiated request.

In some examples, the UE 115-a may include a plurality of radio resources or modems, including at least one VoLTE-capable modem and at least one VoWiFi-capable modem. UE 115-a may be registered for VoWiFi and may be registered for IMS voice over packet switch (VoPS) on the LTE network. The IMS may provide the architectural framework for delivering IP multimedia services that are used in some examples of a handover process from the LTE network to a WiFi network. VoLTE may be based on the IMS and may provide specific profiles for control and media planes associated with voice service on the LTE network. In contrast, in some examples of the present aspects, a smart airplane or other smart operating modes may be employed. For example, in the wireless communications environment 200, the UE 115-a detects the active voice call on a VoLTE-capable modem (e.g., a first radio resource of the UE 115-a). The UE 115-a also detects that a WiFi network is available via wireless link 127-a to AP 107-a and determines that the WiFi network is capable of supporting a transfer of the active voice call (e.g., by verifying necessary functionality and connectivity, proper signal strength based on received signal strength indicator (RSSI) and signal-to-noise ratio (SNR) performance metrics, etc.). The UE 115-a may provide a notification 217 that a call is active and may prompt the user whether to transfer the active voice call to the WiFi network. In implementations where the smart airplane mode disables all radio resources, the notification 217 may include a message that switching to the smart airplane mode will drop the active voice call unless the call is transferred to the WiFi network and the WiFi radio is temporarily kept “on.” If the user selects to keep the active voice call active, the UE 115-a communicates and interacts with an IMS to perform a handover process that transfers the active voice call to a VoWiFi-capable modem (e.g., a second radio resource of the UE 115-a).

The UE 115-a will then disable the VoLTE-capable modem as well as any other cellular-based radio resources of the UE 115-a while keeping the VoWiFi-capable modem active. In this manner, disabling the cellular-based radio resources of the UE 115 may include deactivating one or more components of the cellular-based radio resources circuitry, powering down the cellular-based radio resources, disabling a transmission path to one or more antennas associated with the cellular-based radio resources, etc. As such, the active voice call will continue while the UE 115-a operates in the smart or ‘modified’ airplane mode (e.g., a mode where all modems designated for cellular service are disabled and at least one modem designated for WiFi is active). In some cases, upon termination of the voice call, the UE 115-a will provide an additional notification 217 that the WiFi network is active and a prompt for the user to disable WiFi or to keep WiFi active.

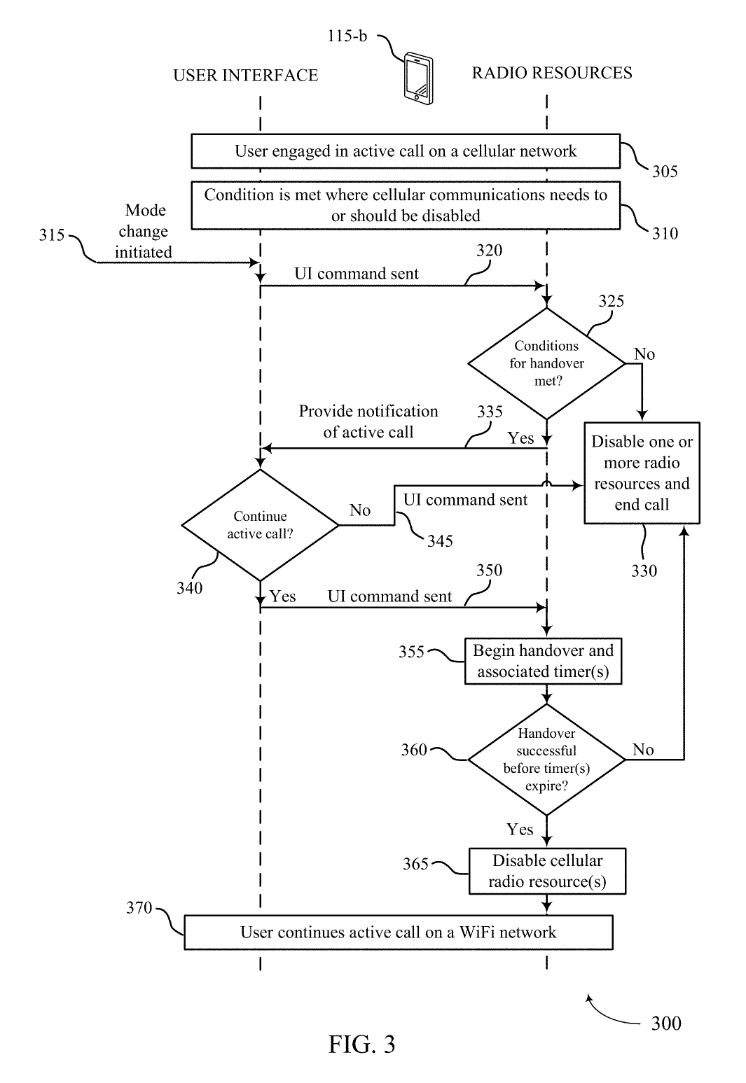

FIG. 3 illustrates an example of a UE 115-b and associated process flow 300 that supports voice and/or video call continuity in accordance with aspects of the present disclosure. In some cases, process flow 300 may represent aspects of techniques performed by a UE 115, base station 105, and/or AP 107 as described with reference to FIGS. 1 and 2. For clarity with respect to some example implementations, process flow 300 operations are illustrated from a user interface perspective and from a radio resources perspective of UE 115-b. It is to be understood that aspects of the present disclosure are not limited to such a delineation of operations.

At operation 305, a user of UE 115-b is engaged in an active call (e.g., a voice and/or video call) and both the user interface and radio resources are used in processing the active call. At operation 310, conditions are met where cellular communications need to be or should be disabled. In operation 310, the condition can be based on non-device related factors such as a request to disable radio resources or device-related factors such as, but not limited to, device settings that automatically trigger a desired operations change on the UE 115-b (e.g., in some cases, including a request from the user authorizing the operations change, a request for the user to authorize the operations change, and in some cases, without prompting the user and automatically making the operations change).

In some examples, an operating mode change is initiated via a user interface module at operation 315, and a user interface command is sent to a radio resources module at operation 320. At operation 325, the radio resources module may determine whether the conditions for handover are met. If the conditions for handover are not met, the radio resources module of UE 115-b may disable one or more, and in some cases, all radio resources thereby ending the call at operation 330. If, however, the conditions for handover are met, the radio resources module of the of UE 115-b may send a notification of the active call to the user interface module so that the user may be provided a notification of the active call (operation 335) and provided an opportunity to respond whether to continue the active call (operation 340).

If the user decides not to continue the active call, a user interface command is sent to the radio resources module at operation 345, and the radio resources module of UE 115-b may disable one or more, and in some cases, all radio resources, thereby ending the call (operation 330). If, however, the user decides to continue the active call, a user interface command is sent to the radio resources module at operation 350 to begin the handover process and associated timer(s) (operation 355). The handover process may involve transferring the active call from a VoLTE-capable modem to a VoWiFi-capable modem.

At operation 360, the radio resources module of UE 115-b determines whether the handover process has completed (e.g., before expiry of the associated timer(s)). If the handover process is not completed successfully, the radio resources module of UE 115-b may disable one or more, and in some cases, all radio resources thereby ending the call (operation 330). If, however, the handover process is successful by the radio resources module of UE 115-b, all cellular radio resource(s) are disabled at operation 365, and the active call continues on the VoWiFi-capable modem using the WiFi network at operation 370.

It is to be understood that in some examples, process flow 300 may similarly relate to transferring of a call from a cellular network to non-cellular networks other than WiFi. For example, a voice call (e.g., or other communications) between the user of UE 115-b and another wireless device proximal to UE 115-b may initially be established via a cellular network and transferred to a radio resource associated with Bluetooth personal area network via a similar handover process described herein.

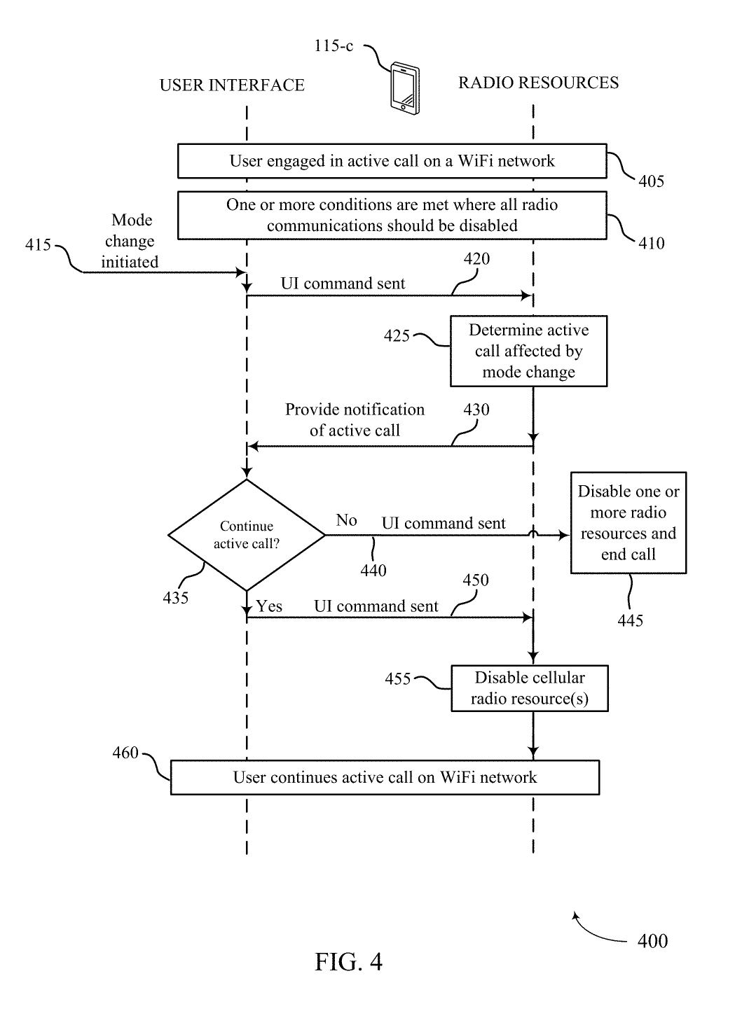

FIG. 4 illustrates an example of a UE 115-c and associated process flow 400 that supports voice and/or video call continuity in accordance with aspects of the present disclosure. In some cases, process flow 400 may represent aspects of techniques performed by a UE 115, base station 105, and/or AP 107 as described with reference to FIGS. 1 and 2. For clarity with respect to some example implementations, process flow 400 operations are illustrated from a user interface perspective and a radio resources perspective of UE 115-c. It is to be understood that aspects of present disclosure are not limited to such a delineation of operations.

At operation 405, a user of UE 115-c is engaged in an active call (e.g., a voice and/or video call) and both user interface and radio resources are used in processing the active call. At operation 410, one or more conditions are met where all radio communications should be disabled. In operation 410, the one or more conditions may be based on non-device related factors such as a request to disable radio resources or device-related factors such as, but not limited to, device settings that automatically trigger a desired operations change on the UE 115-c (e.g., in some cases, including a request from the user authorizing the operations change, a request for the user to authorize the operations change, and in some cases, without prompting the user and automatically making the operations change).

In some examples, an operating mode change is initiated via a user interface module at operation 415. For example, the operating mode change may be an airplane mode that disables all radio resources or a very low power mode where the UE 115-c initiates a sequence to disable all radio resources. A user interface command is sent to a radio resources module at operation 420.

For the purposes of call flow 400, the active call is on a VoWiFi radio resource or modem that is wirelessly coupled to a WiFi network. However, for example, in accordance with the smart airplane mode, at operation 425, the radio resources module determines that the active call is affected by the operating mode change, and the radio resources module of UE 115-c may send a notification of the active call to the user interface module so that the user can be provided a notification of the active call (operation 430). The user may respond whether to continue the active call (operation 435).

If the user decides not to continue the active call, a user interface command is sent to the radio resources module at operation 440, and the radio resources module of UE 115-c disables all radio resources thereby ending the call (operation 445). If, however, the user decides to continue the active call, a user interface command is sent to the radio resources module of UE 115-c at operation 450 to keep the VoWiFi-capable modem active and disable all cellular radio resource(s) or modem(s) (operation 455). Thus, the active call continues on the VoWiFi-capable modem using the WiFi network at operation 460.

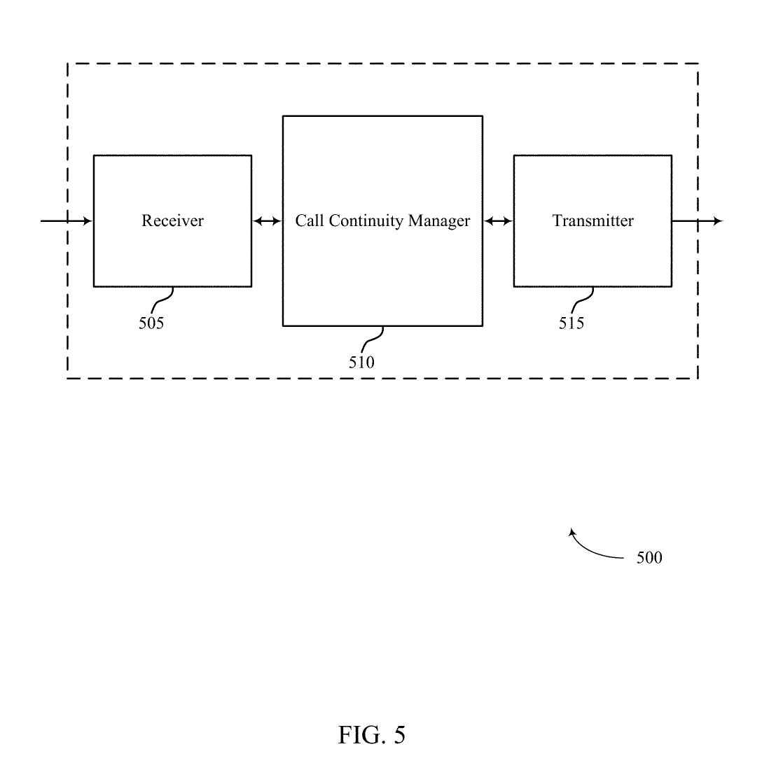

FIG. 5 shows a block diagram of a wireless device 500 that supports voice and/or video call continuity in accordance with various aspects of the present disclosure. Wireless device 500 may be an example of aspects of a UE 115 described with reference to FIGS. 1 through 4. Wireless device 500 may include receiver 505, call continuity manager 510, and transmitter 515. Wireless device 500 may also include a processor. Each of these components may be in communication with each other.

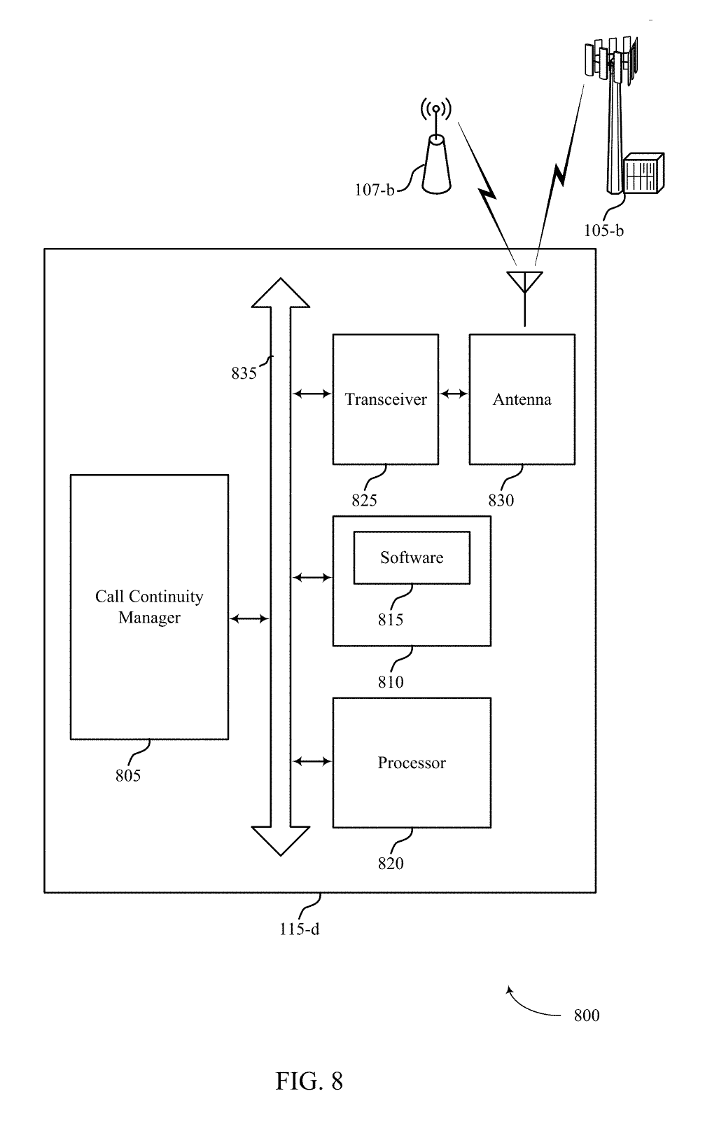

The receiver 505 may receive information such as packets, user data, or control information associated with various information channels (e.g., control channels, data channels, and information related to voice and video call continuity, etc.). Information may be passed on to other components of the device. The receiver 505 may be an example of aspects of the transceiver 825 described with reference to FIG. 8.

The call continuity manager 510 may detect a desired operations change on the UE 115 from a first operational state to a second operational state which uses different resources (e.g., a different number or amount of radio resources) than the first operational state, determine that there is an active call on a first radio resource of the UE 115, perform a handover process to transfer the active call from the first radio resource of the UE 115 to a second radio resource of the UE 115 based on the detecting the operations change, the second radio resource providing a wireless service different than that provided by the first radio resource, and disable the first radio resource based on completing the handover process. The call continuity manager 510 may also be an example of aspects of the call continuity manager 805 described with reference to FIG. 8.

The transmitter 515 may transmit signals received from other components of wireless device 500. In some examples, the transmitter 515 may be collocated with a receiver in a transceiver module. For example, the transmitter 515 may be an example of aspects of the transceiver 825 described with reference to FIG. 8. The transmitter 515 may include a single antenna, or it may include a plurality of antennas.

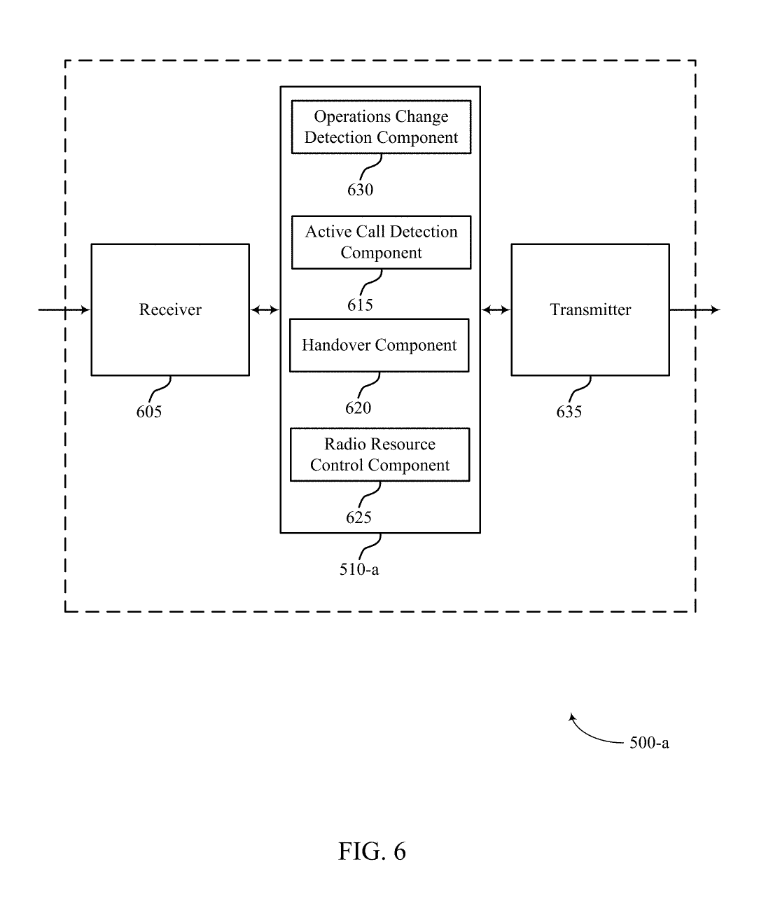

FIG. 6 shows a block diagram of a wireless device 500-a that supports voice and/or video call continuity in accordance with various aspects of the present disclosure. Wireless device 500-a may be an example of aspects of a wireless device 500 or a UE 115 described with reference to FIGS. 1 through 5. Wireless device 500-a may include receiver 605, call continuity manager 510-a, and transmitter 635. Wireless device 500-a may also include a processor. Each of these components may be in communication with each other.

The receiver 605 may receive information which may be passed on to other components of the device. The receiver 605 may also perform the functions described with reference to the receiver 505 of FIG. 5. The receiver 605 may be an example of aspects of the transceiver 825 described with reference to FIG. 8.

The call continuity manager 510-a may be an example of aspects of call continuity manager 510 described with reference to FIG. 5. The call continuity manager 510-a may include active call detection component 615, handover component 620, radio resource control component 625, and operations change detection component 630. The call continuity manager 510-a may be an example of aspects of the call continuity manager 805 described with reference to FIG. 8.

The active call detection component 615 may determine that there is an active call on a first radio resource. In some cases, the active call is, for example, one of a voice call or a video call. In some cases, the active call is on a cellular network (e.g., LTE network, GSM network, CDMA network, etc.) and, for example, may be associated with a preference for using the cellular network (e.g., an operating mode that prefers using a cellular network for voice and/or video communications or the like over other networks such as a WiFi network that supports voice over wireless fidelity (VoWiFi)). In some cases, the first radio resource is associated with a cellular network and the second radio resource is associated with VoWiFi network.

The operations change detection component 630 may detect a desired operations change of the wireless device 500-a from a first operational state to a second operational state. The second operational state may use a different number or amount of radio resources than the first operational state. In some cases, the detecting the desired operations change comprises detecting an operating mode change to a limited radio resources operating mode. For example, the limited radio resources operating mode can be a modified or smart airplane mode by which all radio resources associated with a cellular network are disabled and at least one radio resource associated with a non-cellular network is active.

In some examples, the detecting the desired operations change comprises detecting a low battery condition. The operations change detection component 630 may receive an auto-generated trigger based on the low battery condition or a user indication to change to the second operational state for conserving power (e.g., a low power mode, a game mode, and/or the like). In other examples, the detecting the desired operations change comprises detecting a change in cellular network services associated with the active call. For example, a change in cellular networks services and/or provider during international roaming scenarios can result in significant cost increases for the user of the wireless device 500-a. In these examples, the operations change detection component 630 may receive one of an auto-generated trigger based on the change in cellular network services or a user indication to change to the second operational state for at least disabling all radio resources associated with the cellular network services.

The handover component 620 may perform a handover process to transfer the active call from the first radio resource to a second radio resource based on the detecting the operations change. The second radio resource may provide a wireless service (e.g., WiFi service) different from that provided by the first radio resource (e.g., LTE service). The radio resource control component 625 may disable the first radio resource based on completing (e.g., successfully completing) the handover process.

The transmitter 635 may transmit signals received from other components of wireless device 500-a. In some examples, the transmitter 635 may be collocated with a receiver in a transceiver module. For example, the transmitter 635 may be an example of aspects of the transceiver 825 described with reference to FIG. 8. The transmitter 635 may utilize a single antenna, or it may utilize a plurality of antennas.

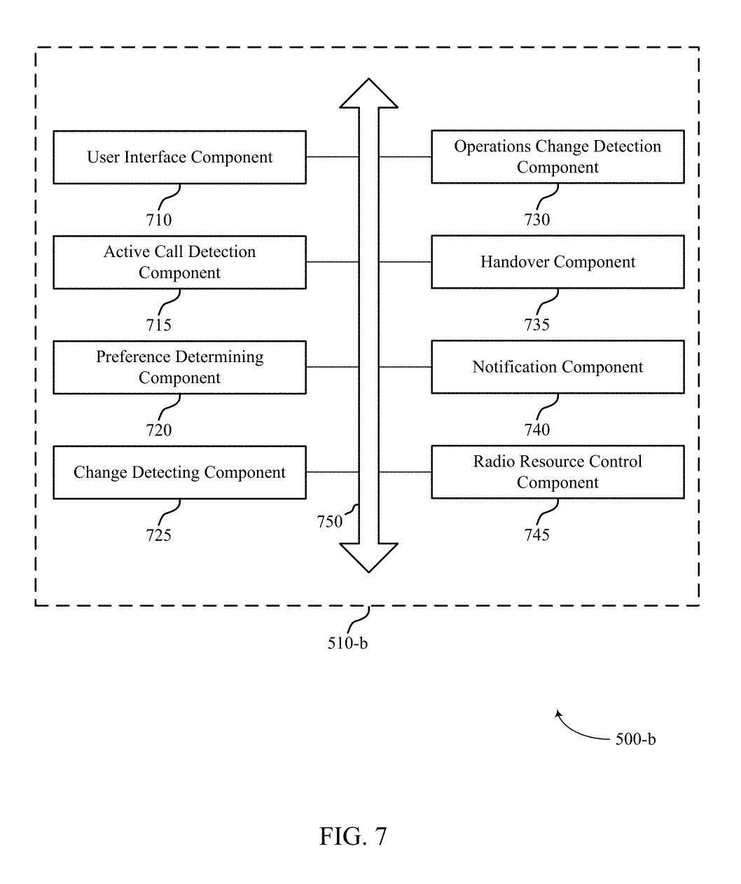

FIG. 7 shows a block diagram of a call continuity manager 510-b of wireless device 500-b, which may be an example of the corresponding component of wireless device 500 or wireless device 500-a. That is, call continuity manager 510-b may be an example of aspects of call continuity manager 510 or call continuity manager 510-a described with reference to FIGS. 5 and 6. The call continuity manager 510-b may also be an example of aspects of the call continuity manager 805 described with reference to FIG. 8

The call continuity manager 510-b may include user interface component 710, active call detection component 715, preference determining component 720, change detecting component 725, operations change detection component 730, handover component 735, notification component 740 and radio resource control component 745. Each of these modules may communicate, directly or indirectly, with one another (e.g., via one or more buses 750)

The user interface component 710 may receive a user call continuity indication to continue the active call. In such cases, the performing the handover process may be further based on the received user call continuity indication. In aspects, additionally or alternatively, the user interface component 710 may receive user network preference information associated with a user preference regarding when a cellular network is to be disabled. For example, a user may select a setting to provide a notification when cellular network service providers change (e.g., roaming). In such cases, the detecting the desired operations change may be based on the user network preference information.

The active call detection component 715 may determine that there is an active call on a first radio resource. In some cases, the active call is on a cellular network and is associated with a preference for using the cellular network. In some cases, the first radio resource is associated with a cellular network and the second radio resource is associated with VoWiFi network.

In some examples, the detecting the desired operations change comprises detecting a change in cellular network services associated with the active call. The preference determining component 720 may determine the preference for using the cellular network based on an operating mode of wireless device 500-b. In such cases, change detecting component 725 may detect a change in cellular network services associated with the active call. The operations change detection component 730 may receive one of an auto-generated trigger based on the change in cellular network services or a user indication to change to the second operational state for at least disabling all radio resources associated with the cellular network services.

In some examples, the detecting the desired operations change comprises detecting a low battery condition. The operations change detection component 730 may receive an auto-generated trigger based on the low battery condition or a user indication to change to the second operational state for conserving power. Generally, the operations change detection component 730 detects a desired operations change on the wireless device 500-b from a first operational state to a second operational state which uses a different number of radio resources than the first operational state.

The handover component 735 may perform a handover process to transfer the active call from the first radio resource to a second radio resource based on the detecting the operations change. The second radio resource of the wireless device 500-b may provide a wireless service different than that provided by the first radio resource.

In some examples, notification component 740 may generate a notification identifying the active call. This notification may be generated based on the operations change detection component 730 detecting a desired operations change. The radio resource control component 745 may disable the first radio resource based on completing (e.g., successfully completing) the handover process.

FIG. 8 shows a diagram of a system 800 including a device that supports voice and/or video call continuity in accordance with various aspects of the present disclosure. For example, system 800 may include UE 115-d, which may be an example of wireless device 500 as described with reference to FIGS. 5-7 or a UE 115 as described with reference to FIGS. 1 through 4.

UE 115-d may also include call continuity manager 805, memory 810, processor 820, transceiver 825, and antenna 830. Each of these modules may communicate, directly or indirectly, with one another (e.g., via one or more buses 835). The call continuity manager 805 may be an example of call continuity manager 510 as described with reference to FIGS. 5 through 7.

Memory 810 may include random access memory (RAM) and read only memory (ROM). The memory 810 may store computer-readable, computer-executable software including instructions that, when executed, cause the processor to perform various functions described herein (e.g., voice and video call continuity functions, etc.). In some cases, the software 815 may not be directly executable by the processor but may cause a computer (e.g., when compiled and executed) to perform functions described herein. The processor 820 may include an intelligent hardware device, (e.g., a central processing unit (CPU), a microcontroller, an application specific integrated circuit (ASIC), etc.).

Transceiver 825 may communicate bi-directionally, via one or more antennas, wired, or wireless links, with one or more networks, as described herein. For example, the transceiver 825 may communicate bi-directionally with base station 105-b or an AP 107-b. The transceiver 825 may also include a modem to modulate the packets and provide the modulated packets to the antennas for transmission, and to demodulate packets received from the antennas. In some cases, UE 115-d may include more than one antenna 830, which may be capable of concurrently transmitting or receiving multiple wireless transmissions.

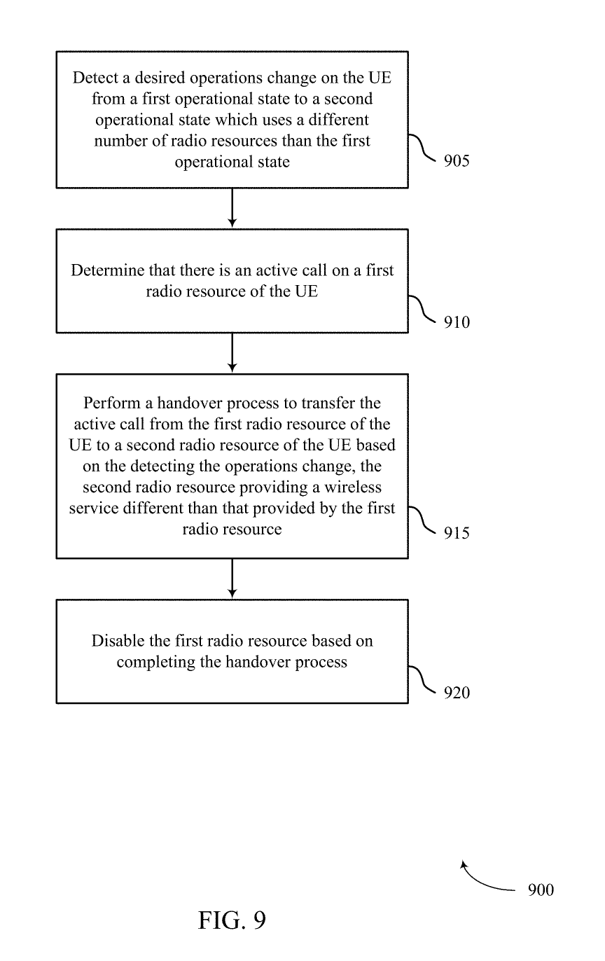

FIG. 9 shows a flowchart illustrating a method 900 for voice and video call continuity in accordance with various aspects of the present disclosure. The operations of method 900 may be implemented by a device such as UE 115, wireless device 500, or components thereof as described with reference to FIGS. 1 through 8. For example, the operations of method 900 may be performed by the call continuity manager 510 of wireless device 500 as described with reference to FIGS. 5-7 or the call continuity manager 805 of UE 115-d as described with reference to FIG. 8. In some examples, the UE 115 may execute a set of codes to control the functional elements of the device to perform the functions described below. Additionally or alternatively, the UE 115 may perform aspects the functions described below using special-purpose hardware.

At block 905, UE 115 may detect a desired operations change from a first operational state to a second operational state. The second operational state may use different radio resources (e.g., a different number or amount of radio resources (e.g., more or less radio resource where the second operational state is an airplane mode, a low power mode, a game mode, or the like) than the first operational state as described herein with reference to FIGS. 2 through 8. In certain examples, the operations of block 905 may be performed by an operations change detection component as described with reference to FIGS. 6 and 7.

At block 910, UE 115 may determine that there is an active call on a first radio resource as described herein with reference to FIGS. 2 through 8. In some implementations, the UE 115 may determine whether there is an active call at the time when the desired operations change is detected, for example, by checking an active call status flag or determining whether radio resources are transmitting or receiving information. In certain examples, the operations of block 910 may be performed by an active call detection component as described with reference to FIGS. 6 and 7.

At block 915, UE 115 may perform an handover process to transfer the active call from the first radio resource to a second radio resource of the UE based on the detecting the desired operations change. The second radio resource may provide a wireless service different from that provided by the first radio resource as described herein with reference to FIGS. 2 through 8. In certain examples, the operations of block 915 may be performed by a handover component as described with reference to FIGS. 6 and 7.

At block 920, UE 115 may disable the first radio resource based on completing (e.g., after successfully completing) the handover process as described herein with reference to FIGS. 2 through 8. In this manner, the disabling of the first radio resource based on the change to the second operational state may be slightly delayed in order to perform any necessary steps via the first radio resource associated with the handover process. In certain examples, the operations of block 920 may be performed by a radio resource control component as described with reference to FIGS. 6 and 7. In some aspects, the user may initiate a change from an existing operating state or mode to a second operating state or mode of the UE 115 by at least one depress of a button on a user interface component 710. In aspects, the steps 905-920 may occur (e.g., automatically without further user input) in response to the at least one depress. In aspects, the method 900 for voice and/or video call continuity may include, disabling the second radio resource (e.g., if enabled in the existing operating state), and re-enabling the second radio resource, for example as part of step 915. In aspects, the method 900 for voice and/or video call continuity may include, maintaining the second radio resource (e.g., if already enabled in the existing operating state), for example as part of step 915. In this manner, a modified or smart airplane mode and/or modified or smart low power mode is introduced Such smart modes provide, for example, efficient (e.g., reduced user input) and seamless transfer of a voice and/or video call from the first radio resource to a second radio resource of the UE when a user has to comply (e.g., quickly) with an attendant that announces that the airplane 210 has been cleared for takeoff and that cellular communications are no longer allowed, and therefore, must be ceased. Thus, such modified or smart modes may enhance a user experience by not disrupting a voice and/or video call in a changing network environment (e.g., when use of certain available means of radio communications are no longer allowed).

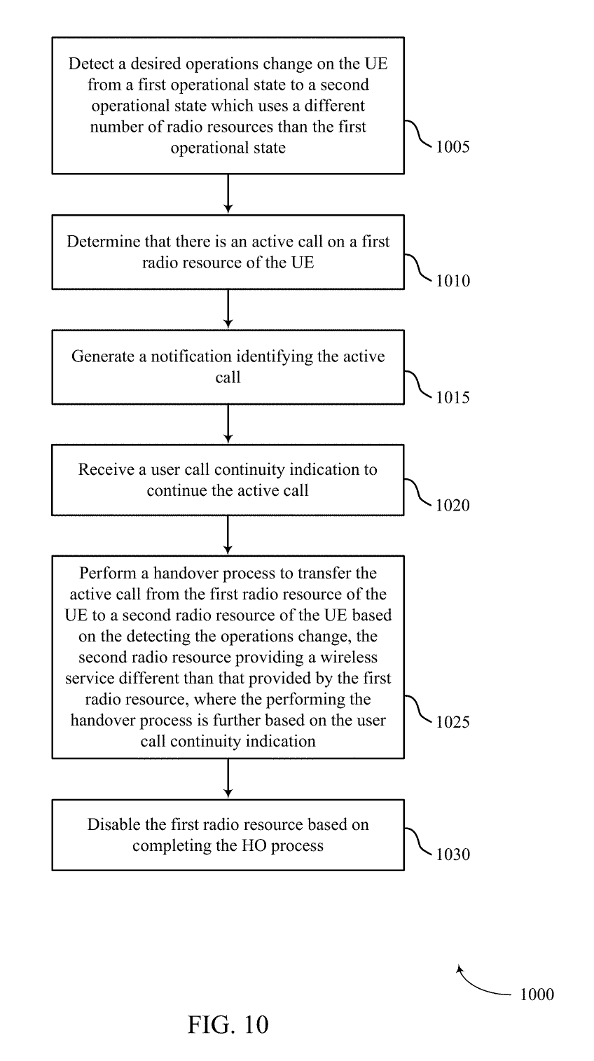

FIG. 10 shows a flowchart illustrating a method 1000 for voice and video call continuity in accordance with various aspects of the present disclosure. The operations of method 1000 may be implemented by a device such as UE 115, wireless device 500, or components thereof as described with reference to FIGS. 1 through 8. For example, the operations of method 1000 may be performed by the call continuity manager 510 of wireless device 500 as described with reference to FIGS. 5-7 or the call continuity manager 805 of UE 115-d as described with reference to FIG. 8. In some examples, the UE 115 may execute a set of codes to control the functional elements of the device to perform the functions described below. Additionally or alternatively, the UE 115 may perform aspects the functions described below using special-purpose hardware.

At block 1005, UE 115 may detect a desired operations change on the UE from a first operational state to a second operational state which uses different radio resources (e.g., a different number or amount of radio resources) than the first operational state as described herein with reference to FIGS. 2 through 8. In some cases, the detecting the desired operations change comprises detecting an operating mode change to a limited radio resources operating mode. The limited radio resources operating mode can be a modified airplane mode by which all radio resources associated with a cellular network are disabled and at least one radio resource associated with a non-cellular network (e.g., a WiFi network) remains or is active.

In other examples, the detecting the desired operations change comprises detecting a low battery condition of the UE 115. In such examples, the UE 115 may receive an auto-generated trigger based on the low battery condition (e.g., when the UE 115 is configured to automatically continue the active call) or a user indication to change to the second operational state for conserving power (e.g., when the UE 115 is configured to require a user response to continue the active call). In yet other examples, the detecting the desired operations change comprises detecting a change in cellular network services associated with the active call. For example, the UE 115 may receive one of an auto-generated trigger based on the change in cellular network services (e.g., when the UE 115 is configured to automatically continue the active call) or a user indication to change to the second operational state for disabling all radio resources associated with the cellular network services (e.g., when the UE 115 is configured to require a user response to continue the active call).

In certain examples, the operations of block 1005 may be performed by one or more of an operations change detection component and/or a preference determining component, as described with reference to FIGS. 6 and 7.

At block 1010, UE 115 may determine that there is an active call on a first radio resource as described herein with reference to FIGS. 2 through 8. The active call can be a voice call (e.g., VoLTE) or a video call (e.g., video telephony where simultaneous, two-way communication comprises both audio and video elements so that participants in a video telephony call can both see and hear each other in real time). In some cases, the active call is a multi-party call and multi-party features and functionality may be used during the active call. In some examples, the active call is on a cellular network and is associated with a preference for using the cellular network. In such examples, the preference for using the cellular network may be based on an operating mode (e.g., a ‘cellular preferred’ mode or configuration) of UE 115. In certain examples, the operations of block 1010 may be performed by an active call detection component as described with reference to FIGS. 6 and 7.

At block 1015, UE 115 may generate a notification identifying the active call as described herein with reference to FIGS. 2 through 8. In certain examples, the operations of block 1015 may be performed by a notification component as described with reference to FIGS. 6 and 7.

At block 1020, UE 115 may receive a user call continuity indication to continue the active call, as described herein with reference to FIGS. 2 through 8. The user call continuity indication can be based on a user interface response by a user of the UE 115 indicating a desire to continue the active call when changing from the first operational state to the second operational state. In certain examples, the operations of block 1020 may be performed by a call continuity indication component as described with reference to FIGS. 6 and 7.

At block 1025, UE 115 may perform a handover process to transfer the active call from the first radio resource to a second radio resource based on the detecting the operations change, the second radio resource providing a wireless service different from that provided by the first radio resource as described herein with reference to FIGS. 2 through 8. In some implementations, the first radio resource may be associated with a cellular network and the second radio resource may be associated with a VoWiFi network. In some examples, the performing the handover process is further based on the user call continuity indication. In certain examples, the operations of block 1025 may be performed by a handover component as described with reference to FIGS. 6 and 7.

At block 1030, UE 115 may disable the first radio resource based on completing the handover process as described above with reference to FIGS. 2 through 8. In certain examples, the operations of block 1030 may be performed by a radio resource control component as described with reference to FIGS. 6 and 7.

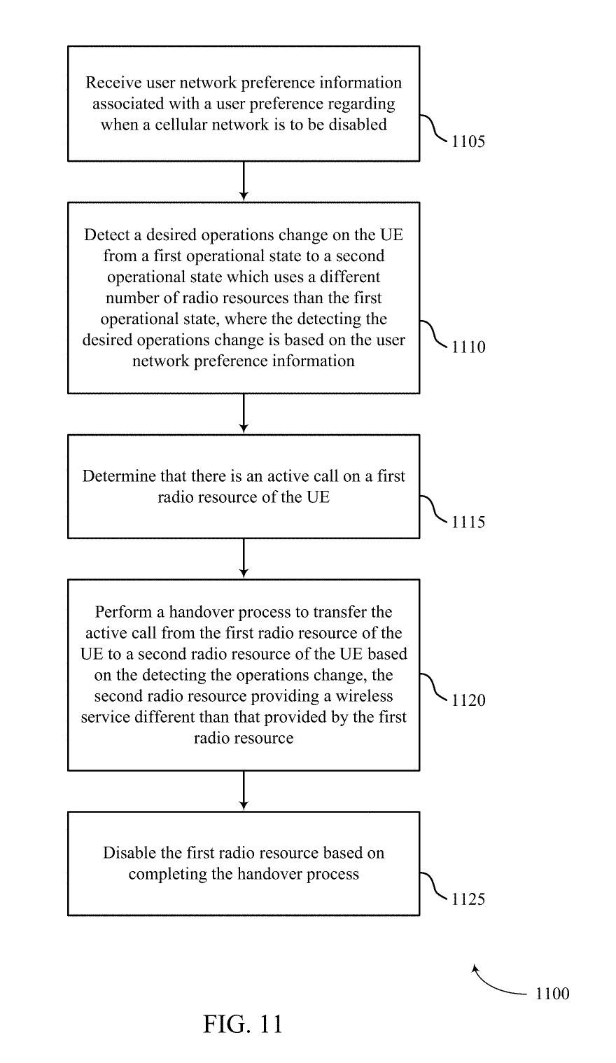

FIG. 11 shows a flowchart illustrating a method 1100 for voice and video call continuity in accordance with various aspects of the present disclosure. The operations of method 1100 may be implemented by a device such as UE 115, wireless device 500, or components thereof as described with reference to FIGS. 1 through 8. For example, the operations of method 1000 may be performed by the call continuity manager 510 of wireless device 500 as described with reference to FIGS. 5-7 or the call continuity manager 805 of UE 115-d as described with reference to FIG. 8. In some examples, the UE 115 may execute a set of codes to control the functional elements of the device to perform the functions described below. Additionally or alternatively, the UE 115 may perform aspects the functions described below using special-purpose hardware.

At block 1105, UE 115 may receive user network preference information associated with a user preference regarding when a cellular network is to be disabled as described herein with reference to FIGS. 2 through 8. The user preference information can be related to certain conditions, settings, and/or triggers for when a user may want to transfer a call from a cellular network to a non-cellular network. This user preference information can be received via user entry into the UE 115, or in some cases, can be received via a transmission from another device (e.g., a base station 105 or an AP 107 or a server operatively coupled thereto where such user preference may be stored). In certain examples, the operations of block 1105 may be performed by a user interface component as described with reference to FIGS. 6 and 7.

At block 1110, UE 115 may detect a desired operations change on the UE from a first operational state to a second operational state which uses a different number of radio resources than the first operational state as described herein with reference to FIGS. 2 through 8. In some examples, the detecting the desired operations change is based on the user network preference information. In certain examples, the operations of block 1110 may be performed by the operations change detection component as described with reference to FIGS. 6 and 7.

At block 1115, UE 115 may determine that there is an active call on a first radio resource as described herein with reference to FIGS. 2 through 8. In certain examples, the operations of block 1115 may be performed by the active call detection component as described with reference to FIGS. 6 and 7.

At block 1120, UE 115 may perform a handover process to transfer the active call from the first radio resource to a second radio resource based on the detecting the operations change, the second radio resource providing a wireless service different from that provided by the first radio resource as described herein with reference to FIGS. 2 through 8. In certain examples, the operations of block 1120 may be performed by a handover component as described with reference to FIGS. 6 and 7.

At block 1125, UE 115 may disable the first radio resource based on completing the handover process as described herein with reference to FIGS. 2 through 8. In certain examples, the operations of block 1125 may be performed by a radio resource control component as described with reference to FIGS. 6 and 7.

It is to be understood that methods 900, 1000, and 110, describe possible implementations, and that the operations and the steps may be rearranged or otherwise modified such that other implementations are possible. In some examples, aspects from two or more of these methods may be combined. For example, aspects of each of the methods may include steps or aspects of the other methods, or other steps or techniques described herein. Thus, aspects of the disclosure may provide for voice and video call continuity when detecting desired operations changes associated with a wireless device.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (WiFi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over an unlicensed and/or shared bandwidth. The description above, however, describes an LTE/LTE-A system for purposes of example, and LTE terminology is used in much of the description above, although the techniques are applicable beyond LTE/LTE-A applications.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “ or ” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: a, b, or c” is intended to cover a, b, c, a-b, a-c, b-c, and a-b-c., as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication comprising:
detecting a desired operations change on the user equipment (UE) from a first operational state to a second operational state which uses a different number of radio resources than the first operational state;
determining that there is an active call on a first radio resource of the UE;
performing a handover process to transfer the active call from the first radio resource of the UE to a second radio resource of the UE based at least in part on the detecting the operations change, the second radio resource providing a wireless service different than that provided by the first radio resource; and
disabling the first radio resource based at least in part on completing the handover process.

2. The method of claim 1, further comprising:
generating a notification identifying the active call.

3. The method of claim 1, further comprising:
receiving a user call continuity indication to continue the active call, wherein the performing the handover process is further based at least in part on the user call continuity indication.

4. The method of claim 1, further comprising:
receiving user network preference information associated with a user preference regarding when a cellular network is to be disabled, wherein the detecting the desired operations change is based at least in part on the user network preference information.

5. The method of claim 1, wherein the active call is on a cellular network and is associated with a preference for using the cellular network.

6. The method of claim 5, further comprising:
determining the preference for using the cellular network based at least in part on an operating mode of the UE.

7. The method of claim 1, wherein the detecting the desired operations change comprises:
detecting an operating mode change to a limited radio resources operating mode.

8. The method of claim 7, wherein the limited radio resources operating mode is a modified airplane mode by which all radio resources associated with a cellular network are disabled and at least one radio resource associated with a non-cellular network remains active.

9. The method of claim 1, wherein the detecting the desired operations change comprises:
detecting a low battery condition; and
receiving an auto-generated trigger based at least in part on the low battery condition or a user indication to change to the second operational state for conserving power.

10. The method of claim 1, wherein the detecting the desired operations change comprises:
detecting a change in cellular network services associated with the active call; and
receiving one of an auto-generated trigger based at least in part on the change in cellular network services or a user indication to change to the second operational state for disabling all radio resources associated with the cellular network services.

11. The method of claim 1, wherein the active call is one of a voice call or a video call.

12. The method of claim 1, wherein the first radio resource is associated with a cellular network and the second radio resource is associated with a voice over wireless fidelity (VoWiFi) network.

13. The method of claim 1, further comprising:
detecting a single depress of a modified airplane mode button on a user interface,
wherein detecting the desired operations change is in response to detecting the single depress;
wherein determining is in response to detecting the single depress; and
wherein performing a handover process to transfer the active call from the first radio resource of the UE to a second radio resource of the UE based at least in part on the detecting the operations change includes disabling the second radio resource and then enabling the second radio resource.

14. An apparatus for wireless communication comprising:
means for detecting a desired operations change from a first operational state to a second operational state which uses a different number of radio resources than the first operational state;
means for determining that there is an active call on a first radio resource;
means for performing a handover process to transfer the active call from the first radio resource to a second radio resource based at least in part on the detecting the operations change, the second radio resource providing a wireless service different from that provided by the first radio resource; and
means for disabling the first radio resource based at least in part on completing the handover process.

15. An apparatus for wireless communication, comprising:
a processor;
memory in electronic communication with the processor; and
one or more instructions stored in the memory and operable, when executed by the processor, to cause the apparatus to:
detect a desired operations change from a first operational state to a second operational state which uses a different number of radio resources than the first operational state;
determine that there is an active call on a first radio resource;
perform a handover process to transfer the active call from the first radio resource to a second radio resource based at least in part on the detecting the operations change, the second radio resource providing a wireless service different than that provided by the first radio resource; and
disable the first radio resource based at least in part on completing the handover process.

16. The apparatus of claim 15, wherein the one or more instructions are further operable to cause the processor to:
generate a notification identifying the active call.

17. The apparatus of claim 15, wherein the one or more instructions are further operable to cause the processor to:
receive a user call continuity indication to continue the active call, wherein the performing the handover process is further based at least in part on the user call continuity indication.

18. The apparatus of claim 15, wherein the one or more instructions are further operable to cause the processor to:
receive user network preference information associated with a user preference regarding when a cellular network is to be disabled, wherein the detecting the desired operations change is based at least in part on the user network preference information.

19. The apparatus of claim 15, wherein the active call is on a cellular network and is associated with a preference for using the cellular network.

20. The apparatus of claim 19, wherein the one or more instructions are further operable to cause the processor to:
determine the preference for using the cellular network based at least in part on an operating mode.

21. The apparatus of claim 15, wherein the one or more instructions operable to cause the processor to detect the desired operations change comprise one or more instructions further operable to cause the processor to:
detect an operating mode change to a limited radio resources operating mode.

22. The apparatus of claim 21, wherein the limited radio resources operating mode is a modified airplane mode by which all radio resources associated with a cellular network are disabled and at least one radio resource associated with a non-cellular network remains active.

23. The apparatus of claim 15, wherein the one or more instructions operable to cause the processor to detect the desired operations change comprise one or more instructions further operable to cause the processor to:
detect a low battery condition; and
receive an auto-generated trigger based at least in part on the low battery condition or a user indication to change to the second operational state for conserving power.

24. The apparatus of claim 15, wherein the one or more instructions operable to cause the processor to detect the desired operations change comprise one or more instructions further operable to cause the processor to:
detect a change in cellular network services associated with the active call; and
receive one of an auto-generated trigger based at least in part on the change in cellular network services or a user indication to change to the second operational state for disabling all radio resources associated with the cellular network services.

25. The apparatus of claim 15, wherein the active call is one of a voice call or a video call.

26. The apparatus of claim 15, wherein the first radio resource is associated with a cellular network and the second radio resource is associated with a voice over wireless fidelity (VoWiFi) network.

27. The apparatus of claim 14, wherein the one or more instructions are further operable to cause the processor to:
detect a single depress of a modified airplane mode button on a user interface,
wherein the instructions operable to cause the processor to detect the desired operations change are further operable to cause the processor to detect the desired operations change is in response to detecting the single depress;
wherein the instructions operable to cause the processor to determine are further operable to cause the processor to determine in response to detecting the single depress; and
wherein the instructions operable to cause the processor to perform a handover process are further operable to cause the processor to perform a handover process to transfer the active call from the first radio resource of the UE to a second radio resource of the UE based at least in part on the detecting the operations change includes disabling the second radio resource and then enabling the second radio resource.

28. A non-transitory computer-readable medium storing code for wireless communication, the code comprising instructions executable to:
detect a desired operations change on a user equipment (UE) from a first operational state to a second operational state which uses a different number of radio resources than the first operational state;
determine that there is an active call on a first radio resource of the UE;
perform a handover process to transfer the active call from the first radio resource of the UE to a second radio resource of the UE based at least in part on the detecting the operations change, the second radio resource providing a wireless service different than that provided by the first radio resource; and
disable the first radio resource based at least in part on completing the handover process.

29. The non-transitory computer-readable medium of claim 28, wherein the instructions are executable to:
generate a notification identifying the active call.

30. The non-transitory computer-readable medium of claim 28, wherein the instructions are executable to:
receive a user call continuity indication to continue the active call, wherein the performing the handover process is further based at least in part on the user call continuity indication.
